(19) United States
(12) Patent Application Publication
(10) Pub. No.: US 2022/0309598 A1
(43) Pub. Date: Sep. 29, 2022

(54) SYSTEMS AND METHODS FOR EVALUATING REAL ESTATE TRANSACTIONS

(71) Applicant: Client Check, Inc., Hickory, NC (US)

(72) Inventor: Victor Garrett Osborne, Hickory, NC (US)

(73) Assignee: Client Check, Inc., Hickory, NC (US)

(21) Appl. No.: 17/704,980

(22) Filed: Mar. 25, 2022

Related U.S. Application Data
(60) Provisional application No. 63/166,586, filed on Mar. 26, 2021.

(51) Int. Cl. G06Q 50/16; G06Q 40/02

(52) U.S. Cl. CPC G06Q 50/16; G06Q 40/025

(57) ABSTRACT

Systems and methods for evaluating a real estate transaction are described herein. Various examples of the technologies described herein provide for the ability of buyers of property to request competing bids from banks and real estate brokers/agents. Various examples of the technologies described herein provide for the ability of sellers to request competing bids. Various examples of the technologies described herein provide for the ability of real estate agents/brokers to receive notifications such as another agent/broker being associated with a client.

### CROSS REFERENCE TO RELATED APPLICATIONS

This application claims the benefit of U.S. Provisional Patent Application No. 63/166,586, filed Mar. 26, 2021, which is incorporated herein by reference in its entirety.

### BACKGROUND

Buying or renting a home or other type of real property, including commercial property, can often be a confusing and byzantine process. Most purchasers of real estate only go through the process once or twice in their lifetime, and thus, have relatively little knowledge of all the factors that may affect the purchase price of their property. An additional factor that exacerbates the issue is that often the purchase of a home is the largest and most important purchase a person will make.

On the other side of the coin, real estate agents (and brokers) are now competing in a more crowded field. Sellers and buyers of property have access to multiple websites for viewing homes and engaging real estate agents. It is becoming increasingly common for buyers to engage more than one real estate agent without informing the real estate agents. In some instances, a buyer may use the services of one real estate agent to perform a significant amount of work and replace the real estate agent with another. These and other factors lead to inefficiencies in real estate transactions.

### BRIEF DESCRIPTION OF THE DRAWINGS

The detailed description is set forth with reference to the accompanying figures. The use of the same reference numbers in different figures indicates similar or identical items or features.

FIG. 1 illustrates an example environment for evaluating real estate transactions, in accordance with some examples of the present disclosure.

FIGS. 2A-2D illustrate a buyer user device having displayed thereon a buyer user interface, in accordance with some examples of the present disclosure.

FIGS. 3A-3C illustrate a seller user device having displayed thereon a seller user interface, in accordance with some examples of the present disclosure.

FIGS. 4A and 4B illustrate an agent user device having displayed thereon an agent user interface, in accordance with some examples of the present disclosure.

FIG. 5 depicts a component level view of an evaluation system, according to the systems and methods described herein.

### DETAILED DESCRIPTION

Examples of the present disclosure comprise systems and methods for evaluating real estate transactions. Various people and/or entities involved in a transaction are provided with identification codes. The codes (which may be numeric or alphanumeric) are used to track information relating to one or more transactions and to associate people and entities with each other. In one example, a buyer is assigned a buyer identification code. The buyer engages with a real estate broker. The real estate broker enters the buyer's name into a user interface for a system that maintains, associates, and tracks identification codes. The buyer is associated with a buyer identification code and is associated with the real estate broker's broker identification code. If another broker or agent (used interchangeable hereinafter) enters the same buyer information, the second broker may be provided information that the buyer is already associated with another real estate broker.

In some examples of the presently disclosed subject matter, a real estate transaction is graded on a transparency score. The transparency score may consider various factors that may be used to determine what a hypothetical fully transparent transaction may involve. For example, a transparency score may include information such as, but not limited to, current broker/agent fees recorded for the area in which the property is located, current broker/agent fees recorded around the time in which the sale/purchase of the property is to be conducted, whether or not the broker/agent fees recorded were negotiated, and the like.

In further examples of the presently disclosed subject matter, examples of a system are provided that provide information to a buyer or seller that allows the buyer or seller to negotiate fees and other costs, such as, but not limited to, closing costs of banks, using the information collected by the system. For example, a user interface is provided that lists broker/agent fees for similar transactions in the same general area. The system can provide information to the buyer or seller that the fees are above, below, or in line with the recorded fees. A buyer or seller can select a “Negotiate Fee” feature that sends a notification to select or selected brokers/agents that the buyer or seller wants a negotiated fee. The brokers/agents can thereafter enter proposed fees to compete for the business. In a similar manner, the system can provide information to the buyer of current bank rates of sales in the same general area. The system can provide a “Negotiate Bank” feature that, when selected, sends a notification to banks that the buyer wants a competitive bank rate for the purchase. Banks can thereafter submit their proposals for selection by the buyer.

Examples of the presently disclosed subject matter can help buyers and sellers evaluate real estate transactions in more efficient manner than conventional methods. Currently, buyers and sellers do not have a centralized location for the collection and dissemination of information relating to real estate transactions. Thus, they are often left with a system that is disjointed and often confusing.

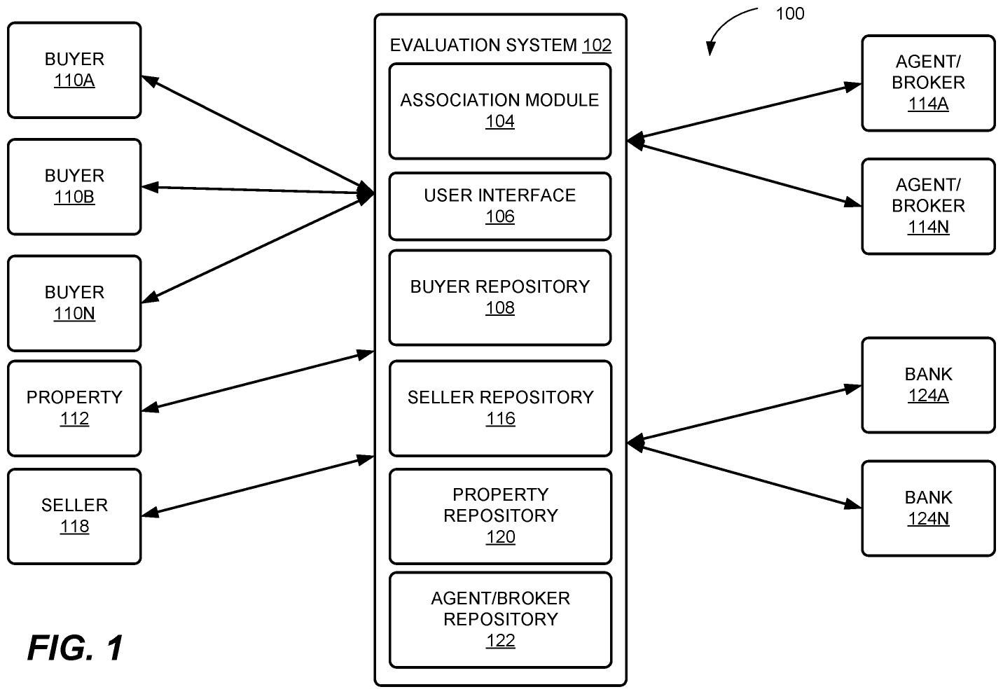

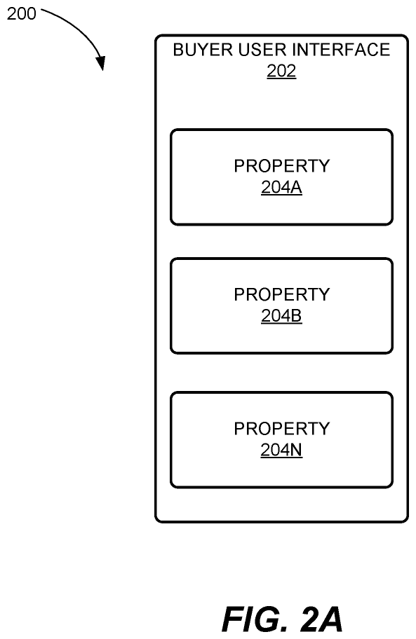

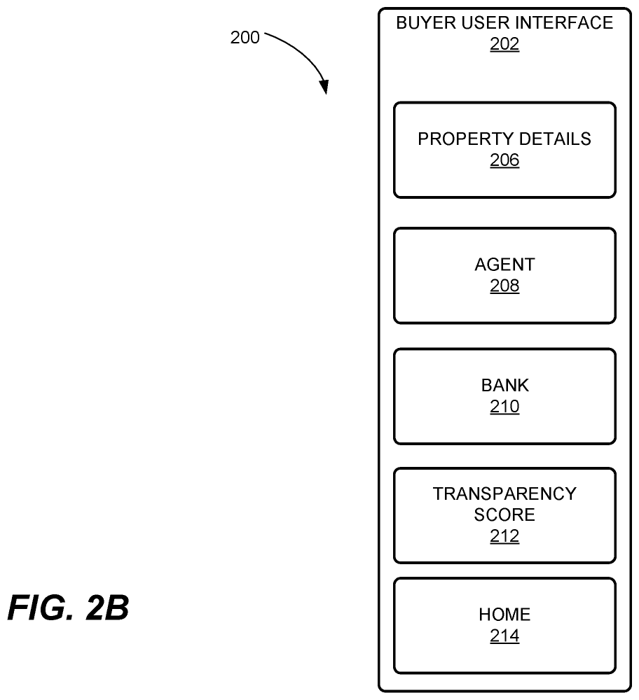

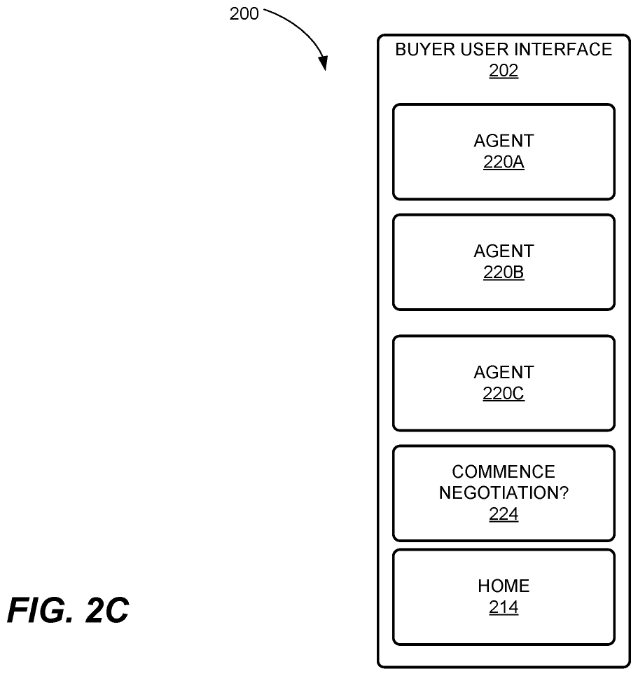

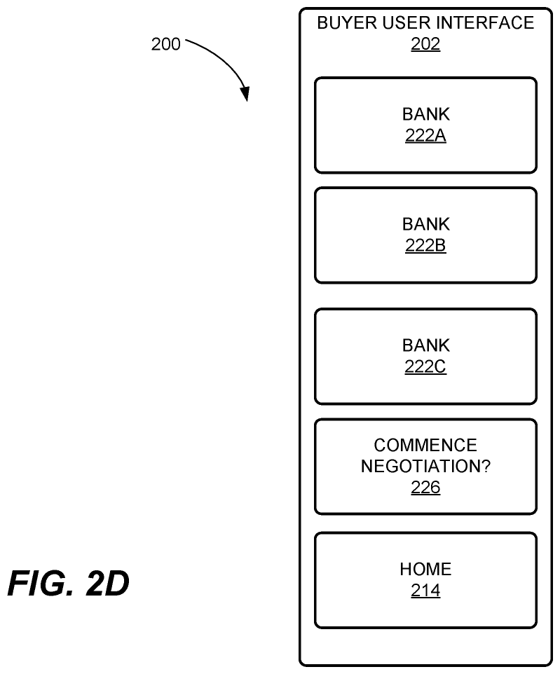

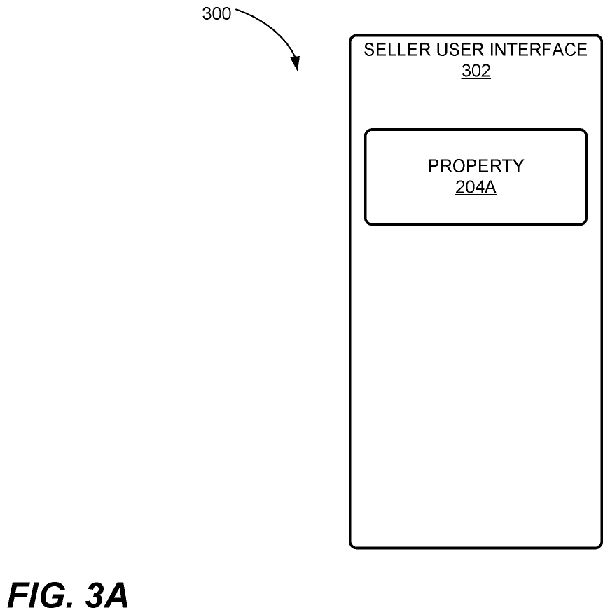

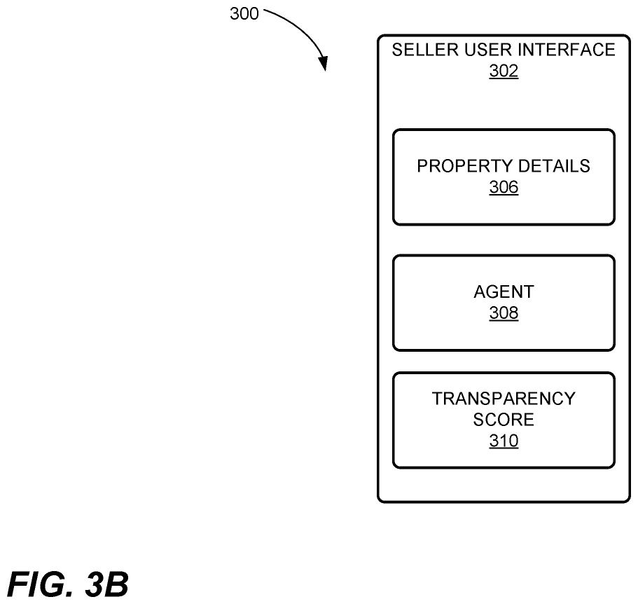

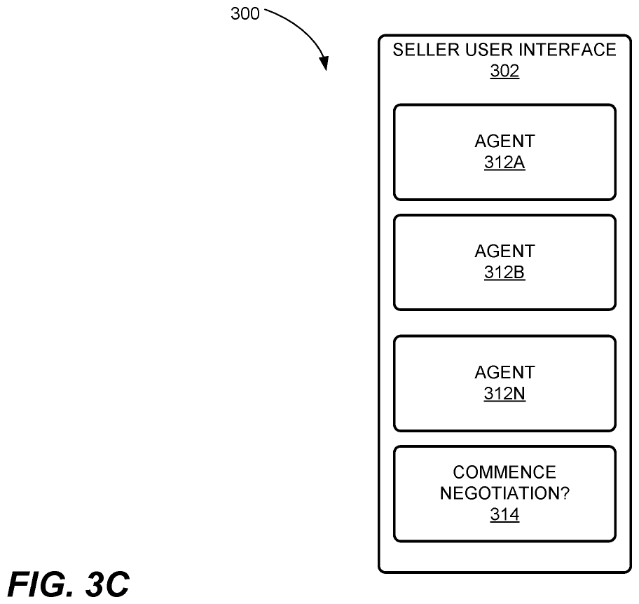

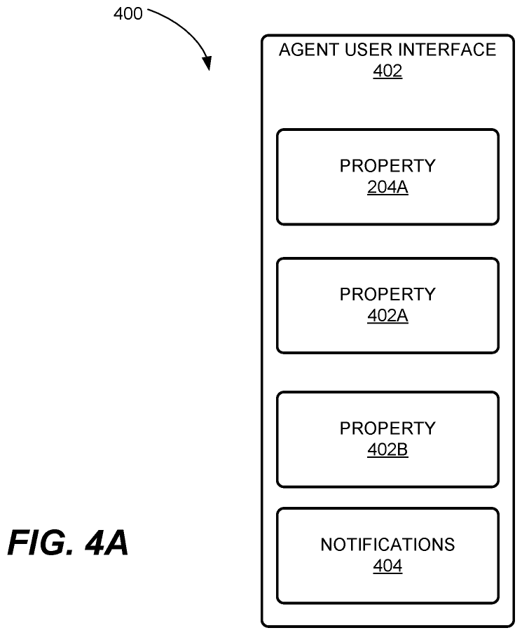

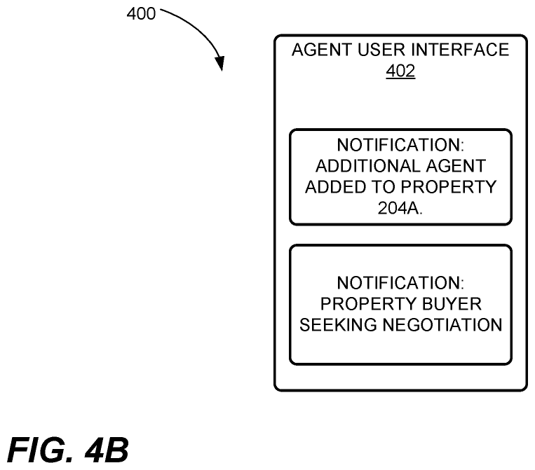

FIG. 1 illustrates an example environment 100 for evaluating real estate transactions, in accordance with some examples of the present disclosure. The environment 100 includes evaluation system 102. The evaluation system 102 acts as a central repository and communication center for providing various functions described herein. In some examples, the evaluation system 102 may be accessible through an Internet connection to a website providing the services. In other examples, the evaluation system 102 may be implemented locally on a device or other system. The presently disclosed subject matter is not limited to any particular manner in which the evaluation system 102 is accessed or provided to users. The evaluation system 102 includes various components that provide various functions described herein. The evaluation system 102 includes an association module 104. The association module 104, as described herein, receives information and provides inputs and outputs as needed. The evaluation system 102 further includes user interface 106. The user interface 106 includes various interfaces that may by used by users of the evaluation system 102. For example, the user interface 106 may be a buyer user interface 202 (FIGS. 2A-2D), a seller user interface 302 (FIGS. 3A-3C), or an agent user interface (FIGS. 4A-4B).

The evaluation system further includes a buyer repository 108. As noted above, the evaluation system 102 receives information from various sources, and one of the pieces of information (“buyer information”) may be one or more buyers 110A-110N. Each of the buyers 110A-110N may be assigned a unique identification code (such as a username or numerical designation). The buyer repository 108 has the buyer 110A-110N information and the associated identification code stored therein. Information for the buyers 110A-110N may be entered into the evaluation system 102 from various entities, including the buyers 110A-110N themselves. For example, the buyer 110A may be looking to purchase a property 112. The buyer 110A may want to use the evaluation system 102. As part of the signup process, the buyer 110A may enter their information and be assigned a buyer identification code. The information for the buyer 110A and the buyer identification code may be stored in the buyer repository 108. In another example, the buyer 110A may have engaged one of the agent/brokers 114A or 114N. In this example, the buyer 110A engages the agent/broker 114A. The agent/broker 114A may enter the information of the buyer 110A to generate a buyer identification code.

The evaluation system further includes a seller repository 116. A seller 118 may be assigned a unique seller identification code (such as a username or numerical designation). The seller repository 116 has stored therein information relating to the seller 118 (“seller information”) and the seller identification code. Information for the seller 118 may be entered into the evaluation system 102 from various entities, including the seller 118. For example, the seller 118 may be looking to sell the property 112. The seller 118 may want to use the evaluation system 102. As part of the signup process, the seller 118 may enter the seller 118 information and be assigned a seller identification code. The information for the seller 118 and the seller identification code may be stored in the seller repository 116. In another example, the seller 118 may have engaged one of the agent/brokers 114A or 114N. In this example, the seller 118 engages the agent/broker 114N. The agent/broker 114N may enter the information of the seller 118 to generate a seller identification code.

The evaluation system 102 may further include a property repository 120 and an agent/broker repository 122. The property repository 120 may have stored therein information about the property 112 as well as other properties not described herein. The information about the property 112, or the “property information,” may include, but is not limited to, photographs or videos of the property, current bids on a property, a timetable (time remaining) for offers to be received, and the like. The agent/broker repository 122 may have stored therein information about the agent/brokers 114A-114N (“agent information about an agent acting as a seller agent for the seller offering a property for sale or an agent acting as a buyer agent for a buyer buying the property”). The evaluation system 102 may further interface with banks 124A and 124N to allow for the negotiation of bank rates relating to fees and interest rates, described in more detail below.

The evaluation system 102 may be used by various entities, such as the buyers, seller, and agents/brokers illustrated in FIG. 1. In one example, a buyer 110A may engage the agent/broker 114A to assist with finding and purchasing the property 112. The agent/broker 114A may enter information relating to the buyer 110A to establish the buyer 110A as a client. The buyer 110A may also enter their information. The association module 104 receives the information and determines that the buyer 110A is associated with the agent/broker 114A and the property 112. The association module 104 may check to see if the buyer 110A is associated with other agent/brokers, such as the agent/broker 114N. If the association module 104 determines that the buyer 110A is associated with both the agent/broker 114A and the agent/broker 114N, the association module 104 may send a notice to both the agent/broker 114A and the agent/broker 114N to inform the agent/broker 114A and the agent/broker 114N that the buyer 110A has engaged the services of more than one agent/broker. This may allow the agent/broker 114A and the agent/broker 114N to compete for the business of the buyer 110A, as well as other potential advantages not described herein.

Once the buyer 110A has determined to move forward with the agent/broker 114A or 114N to purchase the property 112, the buyer 110A may be presented with information to help the buyer 110A complete the transaction, described in more detail in FIGS. 2A-2D.

FIGS. 2A-2D illustrate a buyer user device 200 having displayed thereon a buyer user interface 202, in accordance with some examples of the present disclosure. Examples of the buyer user device 200 can include, but are not limited to, any portable electronic devices that can generate, request, receive, transmit, or exchange voice, video, and/or digital data over a network. The buyer user interface 202 is provided by the user interface 106 of the evaluation system 102. In some examples, the buyer user interface 202 may be generated by a local application executing on the buyer user device 200 that interfaces with the evaluation system 102.

Illustrated in a “home” screen of the buyer user interface 202 are selectable links to properties 204A-204N. The properties 204A-204N may be one or more properties the buyer is interested in purchasing. When selected, the links may provide additional information relating to the property, as illustrated in FIG. 2B.

In FIG. 2B, the buyer user interface 202 received a selection of the property 204A in FIG. 1. The buyer user interface 202 thereafter changes to include various information about the property 204A such as property details 206. The property details 206 can include the location of the property, price, and the like, as well as a selectable link to the property 204A on a website. The buyer user interface 202 further includes information relating to an agent 208 the buyer has selected. If the buyer has not selected the agent 208, the agent 208 may be a selectable link to select an agent 208, as illustrated in FIG. 2C.

In FIG. 2C, the buyer user interface 202 received a selection of the agent 208 in FIG. 2B. The buyer user interface 202 thereafter changes to include an identification of agents 220A-220C that may be selected by the buyer to assist with finding and purchasing the property 204A. In some examples, the buyer user interface 202 may include a commence negotiation input 224. Upon the receipt of an input from a user, the commence negotiation input 224 transmits a request to one or more agents/brokers to provide to the buyer their best rate/commission to assist with the purchase of the property 204A. The information provided by the agents/brokers may also include their years of experience, their experience and knowledge in location around the property 204A as well as other factors that the agents/brokers may feel necessary to provide. The buyer may select one of the agents, whereby the selection associates the buyer and property with the selected agent. The buyer may thereafter select the home button 214 to return to a prior screen, such as the buyer user interface of FIG. 2B.

Returning to FIG. 2B, the buyer user interface 202 further includes a selectable input for a bank 210. If a bank has already been selected, the bank 210 may include information about the bank selected by the buyer. If a bank has not already been selected, the bank 210 may cause the buyer user interface 202 to move to the configuration of FIG. 2D.

In FIG. 2D, the buyer user interface 202 received a selection of the bank 210 in FIG. 2B. The buyer user interface 202 thereafter changes to include an identification of banks 222A-222C that may be selected by the buyer to assist with the purchasing the property 204A. In some examples, the buyer user interface 202 may include a commence negotiation input 226. Upon the receipt of an input from a user, the commence negotiation input 226 transmits a request to one or more banks to provide to the buyer their best rate for the purchase of the property 204A. The information provided by the banks may also include other information that the banks may feel necessary to provide. The buyer may select one of the banks 222A-222C, whereby the selection associates the buyer, property, agent, and now bank with the property 204A. The buyer may thereafter select the home button 214 to return to a prior screen, such as the buyer user interface of FIG. 2B.

As mentioned briefly above, often real estate transactions are disjointed and difficult to navigate. To help buyers, the buyer user interface 202 further includes a transparency score 212 indication. The transparency score 212 may be a score based on various factors that relate to how much information the buyer has relating to a transaction in relation to a theoretical transaction in which the buyer knows all potential information. Information that may be used to generate a transparency score include, but is not limited to: commissions for agents/brokers in the area of the property 204A, bank rates available, experience levels of agents/brokers, the familiarity of agents/brokers in the area of the property 204A, historical commission/rates, and the like. The transparency score 212 may be based on a numerical scale, such as from 1 to 10 with 1 being the least transparent to 10 being the most transparent, or a color grade with red being the least transparent to green being the most transparent. As the buyer uses the buyer user interface 202, the transparency score 212 may be changed based on input. For example, if the buyer selects the commence negotiation 224 input of FIG. 2C, the transparency score may increase because the buyer may have additional information relating to agents, including competitive commissions, then before the use of the commence negotiations 224 input. In a similar manner, if the buyer selects the commence negotiation input 226 of FIG. 2D, the transparency score may increase because the buyer may have additional information relating to banks, including fees, closing costs, and the like, then before the use of the commence negotiations input 226. As the buyer is provided more information, including information provided by the selected agent, the transparency score 212 may increase.

FIGS. 3A-3C illustrate a seller user device 300 having displayed thereon a seller user interface 302, in accordance with some examples of the present disclosure. Examples of the seller user device 300 can include, but are not limited to, any portable electronic devices that can generate, request, receive, transmit, or exchange voice, video, and/or digital data over a network. The seller user interface 302 is provided by the user interface 106 of the evaluation system 102. In some examples, the seller user interface 302 may be generated by a local application executing on the seller user device 300 that interfaces with the evaluation system 102.

Illustrated in a “home” screen of the seller user interface 302 is a selectable link to the property 204A, which the seller is selling. When selected, the links may provide additional information relating to the property, as illustrated in FIG. 3B.

In FIG. 3B, the seller user interface 302 received a selection of the property 204A in FIG. 1. The seller user interface 302 thereafter changes to include various information about the property 204A such as property details 306. The property details 306 can include the location of the property, price, and the like, as well as a selectable link to the property 204A on a website. The seller user interface 302 further includes information relating to an agent 308 the buyer has selected. If the buyer has not selected the agent 308, the agent 308 may be a selectable link to select an agent 308, as illustrated in FIG. 3C.

In FIG. 3C, the seller user interface 302 received a selection of the agent 308 in FIG. 3B. The seller user interface 302 thereafter changes to include an identification of agents 312A-312N that may be selected by the buyer to assist with finding and purchasing the property 204A. In some examples, the seller user interface 302 may include a commence negotiation input 314. Upon the receipt of an input from a user, the commence negotiation input 314 transmits a request to one or more agents/brokers to provide to the seller their best rate/commission to assist with the sale of the property 204A. The information provided by the agents/brokers may also include their years of experience, their experience and knowledge in location around the property 204A as well as other factors that the agents/brokers may feel necessary to provide. The seller may select one of the agents, whereby the selection associates the seller and property with the selected agent.

Returning to FIG. 3B, the seller user interface 302 further includes a transparency score 310 indication. The transparency score 310 may be a score based on various factors that relate to how much information the seller has relating to a transaction in relation to a theoretical transaction in which the seller knows all potential information. Information that may be used to generate a transparency score include, but is not limited to: commissions for agents/brokers in the area of the property 204A, bank rates available, experience levels of agents/brokers, the familiarity of agents/brokers in the area of the property 204A, historical commission/rates, and the like. The transparency score 310 may be based on a numerical scale, such as from 1 to 10 with 1 being the least transparent to 10 being the most transparent, or a color grade with red being the least transparent to green being the most transparent. As the seller uses the seller user interface 302, the transparency score 310 may be changed based on input. For example, if the seller selects the commence negotiation input 314 of FIG. 3C, the transparency score 310 may increase because the seller may have additional information relating to agents, including competitive commissions, then before the use of the commence negotiations input 314. As the seller is provided more information, including information provided by the selected agent, the transparency score 310 may increase.

FIGS. 4A and 4B illustrate an agent user device 400 having displayed thereon an agent user interface 402, in accordance with some examples of the present disclosure. Examples of the agent user device 400 can include, but are not limited to, any computer, computing device, or portable electronic devices that can generate, request, receive, transmit, or exchange voice, video, and/or digital data over a network. The agent user interface 402 is provided by the user interface 106 of the evaluation system 102. In some examples, the agent user interface 402 may be generated by a local application executing on the agent user device 400 that interfaces with the evaluation system 102. Illustrated in a “home” screen of the agent user interface 402 are selectable links to properties 204A, 402A, and 402B, which the agent is listed as the agent of record. When selected, the links may provide additional information relating to the properties.

The agent user interface 402 further includes a notifications interface 404 that is a selectable link that provides information relating to notifications the agent has relating to one or more of the properties 204A, 402A, or 402B. When selected, the agent user interface 402 illustrates notifications, examples of which are illustrated in FIG. 4B. In FIG. 4B, example notifications are indicated. For example, a notification may be provided to the agent that another agent has been associated with one of the properties 204A, 402A, or 402B. In another example, a notification may be provided to the agent that a buyer of a property is seeking to negotiation commissions for the property.

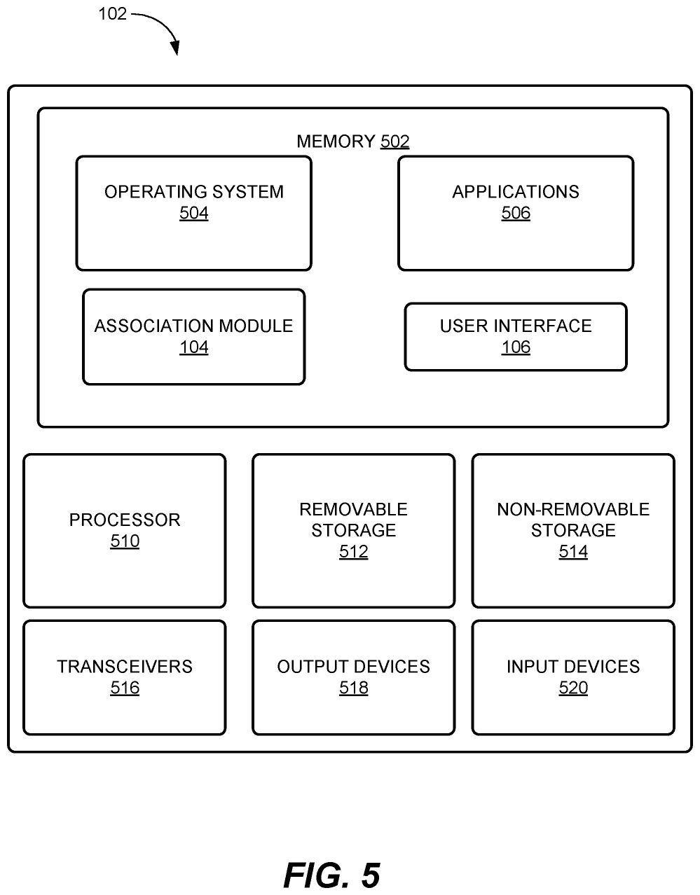

FIG. 5 depicts a component level view of the evaluation system 102, according to the systems and methods described herein. The evaluation system 102 could be any device or combination of devices capable of providing the functionality associated with the systems and methods described herein. The evaluation system 102 can comprise several components, modules, software functions, or computing devices to execute the above-mentioned functions. The evaluation system 102 may be comprised of hardware, software, or various combinations thereof. As discussed below, the evaluation system 102 can comprise memory 502 including an operating system (OS) 504 and one or more standard applications 506. The standard applications 506 may include applications that provide for communication with a cellular network and the evaluation system 102. The OS 504 varies depending on the manufacturer of the evaluation system 102. The OS 504 contains the modules and software that support basic functions of the evaluation system 102, such as scheduling tasks, executing applications, and controlling peripherals. In some examples, the OS 504 can enable the association module 104 and the user interface 106, and provide other functions, as described above, via transceiver(s) 516. The OS 504 can also enable the evaluation system 102 to send and retrieve other data and perform other functions.

The evaluation system 102 can also comprise one or more processors 510 and one or more of removable storage 512, non-removable storage 514, transceiver(s) 516, output device(s) 518, and input device(s) 520. In various implementations, the memory 502 can be volatile (such as random access memory (RAM)), non-volatile (such as read only memory (ROM), flash memory, etc.), or some combination of the two.

In some implementations, the processor(s) 510 can be one or more central processing units (CPUs), graphics processing units (GPUs), both CPU and GPU, or any other combinations and numbers of processing units. The evaluation system 102 may also include additional data storage devices (removable and/or non-removable) such as, for example, magnetic disks, optical disks, or tape. Such additional storage is illustrated in FIG. 5 by removable storage 512 and non-removable storage 514. Various data may be stored in the removable storage 512 and/or the non-removable storage including, but not limited to, the buyer repository 108, the seller repository 116, the property repository 120, and the agent/broker repository 122.

Non-transitory computer-readable media may include volatile and nonvolatile, removable and non-removable tangible, physical media implemented in technology for storage of information, such as computer readable instructions, data structures, program modules, or other data. The memory 502, removable storage 512, and non-removable storage 514 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information and which can be accessed by the evaluation system 102. Any such non-transitory computer-readable media may be part of the evaluation system 102 or may be a separate database, databank, remote server, or cloud-based server.

In some implementations, the transceiver(s) 516 include any transceivers known in the art. In some examples, the transceiver(s) 516 can include wireless modem(s) to facilitate wireless connectivity with other components (e.g., between the evaluation system 102 and a wireless modem that is a gateway to the Internet), the Internet, and/or an intranet. Specifically, the transceiver(s) 516 can include one or more transceivers that can enable the evaluation system 102 to send and receive data. Thus, the transceiver(s) 516 can include multiple single-channel transceivers or a multi-frequency, multi-channel transceiver to enable the evaluation system 102 to send and receive requests, inquiries, data entry, video calls, audio calls, messaging, etc. The transceiver(s) 516 can enable the evaluation system 102 to connect to multiple networks including, but not limited to 2G, 3G, 4G, 5G, and Wi-Fi networks. The transceiver(s) can also include one or more transceivers to enable the evaluation system 102 to connect to future (e.g., 6G) networks, Internet-of-Things (IoT), machine-to machine (M2M), and other current and future networks.

The transceiver(s) 516 may also include one or more radio transceivers that perform the function of transmitting and receiving radio frequency communications via an antenna (e.g., Wi-Fi or Bluetooth®. In other examples, the transceiver(s) 516 may include wired communication components, such as a wired modem or Ethernet port, for communicating via one or more wired networks. The transceiver(s) 516 can enable the evaluation system 102 to facilitate audio and video calls, download files, upload files, access web applications, and provide other communications associated with the systems and methods, described above.

In some implementations, the output device(s) 518 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 518 can also include speakers, or similar devices, to play sounds or ringtones when an audio call or video call is received. Output device(s) 518 can also include ports for one or more peripheral devices, such as headphones, peripheral speakers, or a peripheral display.

In various implementations, input device(s) 520 include any input devices known in the art. For example, the input device(s) 520 may include a camera, a microphone, or a keyboard/keypad. The input device(s) 520 can include a touch-sensitive display or a keyboard to enable users to enter data and make requests and receive responses via web applications (e.g., in a web browser), make audio and video calls, and use the standard applications 506, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 420 and an output device 418.

The presently disclosed examples are considered in all respects to be illustrative and not restrictive. The scope of the disclosure is indicated by the appended claims, rather than the foregoing description, and all changes that come within the meaning and range of equivalents thereof are intended to be embraced therein.

1. A non-transitory computer-readable storage medium having computer-executable instructions stored thereupon that, when executed by a computer, cause the computer to perform acts comprising:
receiving, at a buyer repository, buyer information and a assigning a buyer identification number to a buyer associated with the buyer information;
receiving, at a property repository, property information about a plurality of properties offered for sale;
receiving, at an agent/broker repository, agent/broker information from a plurality of agents/brokers; and
associating, at an association module, the buyer identification with a first agent/broker of the plurality of agents/brokers and a first property of the properties of the plurality of properties.

2. The non-transitory computer-readable storage medium of claim 1, further comprising computer-executable instructions that, when executed by the computer, cause the computer to perform the act comprising receiving, at seller repository, seller information of a seller associated with each of the plurality of properties.

3. The non-transitory computer-readable storage medium of claim 1, further comprising computer-executable instructions that, when executed by the computer, cause the computer to perform the act comprising generating a notice to the first agent/broker of the plurality of agent/brokers that the buyer is associated with a second agent/broker of the plurality of agents/brokers.

4. The non-transitory computer-readable storage medium of claim 1, further comprising computer-executable instructions that, when executed by the computer, cause the computer to perform the act comprising providing a buyer user interface, the buyer user interface comprising at least one selectable link to the property information about the plurality of properties offered for sale.

5. The non-transitory computer-readable storage medium of claim 1, further comprising computer-executable instructions that, when executed by the computer, cause the computer to perform the act comprising providing a buyer user interface, the buyer user interface comprising a plurality of selectable links to the property information about a selected property of the plurality of properties offered for sale.

6. The non-transitory computer-readable storage medium of claim 5, wherein the plurality of selectable links to the property information about the selected property of the plurality of properties offered for sale comprises property details such as a price of the property.

7. The non-transitory computer-readable storage medium of claim 6, wherein the plurality of selectable links to the property information about the selected property of the plurality of properties offered for sale further comprises agent information for a plurality of agents available to act as a buyer agent for the buyer.

8. The non-transitory computer-readable storage medium of claim 7, wherein agent information for at least one agent available to act as the buyer agent for the buyer comprises a best agent rate for acting as the buyer agent for the buyer.

9. The non-transitory computer-readable storage medium of claim 5, wherein the plurality of selectable links to the property information about the selected property of the plurality of properties offered for sale comprises a bank selectable link configured to provide information about a plurality of banks available to provide a loan and a best bank loan rate from each of the plurality of banks.

10. The non-transitory computer-readable storage medium of claim 5, wherein the plurality of selectable links to the property information about the selected property of the plurality of properties offered for sale comprises a transparency score, wherein the transparency score is based on providing one or more of the following: commissions for agents/brokers in an area of the property, bank rates available, experience levels of the agents/brokers in the area of the property, and historical commissions of the agents/brokers in the area of the property.

11. A system comprising:
a memory storing computer-executable instructions; and
a processor in communication with the memory, the computer-executable instructions causing the processor to perform acts comprising:
receiving, at a buyer repository, buyer information and a assigning a buyer identification number to a buyer associated with the buyer information;
receiving, at a property repository, property information about a plurality of properties offered for sale;
receiving, at an agent/broker repository, agent/broker information from a plurality of agents/brokers; and
associating, at an association module, the buyer identification with a first agent/broker of the plurality of agents/brokers and a first property of the properties of the plurality of properties.

12. The system of claim 11, further comprising computer-executable instructions for:
receiving, at seller repository, seller information of a seller associated with each of the plurality of properties; and
generating a notice to the first agent/broker of the plurality of agent/brokers that the buyer is associated with a second agent/broker of the plurality of agents/brokers.

13. The system of claim 11, further comprising computer-executable instructions for providing a buyer user interface, the buyer user interface comprising:
at least one selectable link to the property information about the plurality of properties offered for sale; and
a plurality of selectable links to the property information about a selected property of the plurality of properties offered for sale.

14. The system of claim 13, wherein the plurality of selectable links to the property information about the selected property of the plurality of properties offered for sale comprises property details such as a price of the property.

15. The system of claim 13, wherein the plurality of selectable links to the property information about the selected property of the plurality of properties offered for sale further comprises agent information for a plurality of agents available to act as a buyer agent for the buyer.

16. The system of claim 15, wherein agent information for at least one agent available to act as the buyer agent for the buyer comprises a best agent rate for acting as the buyer agent for the buyer.

17. The system of claim 13, wherein the plurality of selectable links to the property information about the selected property of the plurality of properties offered for sale comprises a bank selectable link configured to provide information about a plurality of banks available to provide a loan and a best bank loan rate from each of the plurality of banks.

18. The system of claim 13, wherein the plurality of selectable links to the property information about the selected property of the plurality of properties offered for sale comprises a transparency score, wherein the transparency score is based on providing one or more of the following: commissions for agents/brokers in an area of the property, bank rates available, experience levels of the agents/brokers in the area of the property, and historical commissions of the agents/brokers in the area of the property.

19. A method, comprising:
receiving property information about a property offered for sale;
receiving seller information about a seller offering the property for sale;
receiving agent information about an agent acting as a seller agent for the seller offering the property for sale;
receiving an input from a buyer to receive property information of the property offered for sale; and
transmitting the property information to the buyer.

20. The method of claim 19, wherein the property information comprises photographs of the property, videos of the property, current bids on the property, and a timetable for remaining offers to be received for the property.
